(19) United States
(12) Patent Application Publication
(10) Pub. No.: US 2008/0043731 A1
(43) Pub. Date: Feb. 21, 2008

(54) Method And Apparatus For Generating Packet Frames For Carrying Data

(75) Inventors: Wei Lih Lim, Singapore (SG); Pek Yew Tan, Singapore (SG); Chalermphol Apichaichalermwongse, Osaka (JP); Kazuhiro Ando, Osaka (JP); Yasuo Harada, Hyogo (JP)

Correspondence Address: GREENBLUM & BERNSTEIN, P.L.C., 1950 ROLAND CLARKE PLACE, RESTON, VA, 20191, US

(73) Assignee: MATSUSHITA ELECTRIC INDUSTRIAL CO., LTD., Osaka (JP)

(21) Appl. No.: 10/597,258

(22) PCT Filed: Feb. 2, 2005
(86) PCT No.: PCT/JP05/02086

§ 371 Date: Sep. 1, 2006

(30) Foreign Application Priority Data
Feb. 4, 2004 (JP) 2004/027746

(51) Int. Cl. H04L 12/56; H04L 12/40; H04L 29/06; H04L 12/46

(52) U.S. Cl. 370/389

(57) ABSTRACT

A conventional packet frame includes a MAC header, one MAC service data unit (MSDU) and a frame FCS. This frame is repeated to send a plurality of MSDUs. A proposed packet frame includes a MAC header, a plurality of MSDUs and a frame FCS. A unique bit pattern is provided in the MAC header to distinguish the proposed packet frame from the conventional packet frame. Thus, the total data stream can be shortened.

### TECHNICAL FIELD

The present invention relates to method and apparatus for generating packet frames for carrying data.

### BACKGROUND ART

In prior art, means to achieve high throughput are being introduced. Although these means can be employed in multiple antenna system to achieve high transmission rate, means to increase the throughput efficiency are not described.

In multiple antennas system, multiple antennas can be activated in the same frequency at the same time to facilitate parallel transmission, with the limitation that the number of transmitting antennas cannot be greater than the number of receiving antennas. Since throughput efficiency is measured as good put over transmission rate, throughput can not be increased effectively without the reduction of overhead in the MAC and PHY. The following is an illustration of the problem introduced by just increasing the transmission rate without overhead reduction at MAC. Under 36 Mbps OFDM PHY, 364 microseconds is required to transmit 1500 octets MSDU without fragmentation. By transmitting 6 MSDUs in a burst and using block acknowledgement, throughput efficiency up to 84% can be achieved. In a MIMO-OFDM system, 144 Mbps transmission rate can be achieved by using 256 QAM at 0.75 coding rate on 2 transmitting antennas and 2 receiving antennas. With that setting, 108 microseconds/356 microseconds is required to transmit a 1500/6000 octets MSDU without fragmentation. By transmitting six 1500 octets MSDUs in a burst and using block acknowledgement, a throughput efficiency up to 62% can be achieved. By transmitting six 6000 octets MSDUs in a burst and using block acknowledgement, a throughput efficiency up to 86% can be achieved. For MSDU size of 1500 octets, BER is required to be 8.78*10⁻⁵ in order to achieve 10% PER. With MSDU size of 6000 octets, to achieve the same level of PER, BER is required to be 2.195*10⁻⁶. MSDUs that are being aggregated and transmitted using a MPDU should permit to be acknowledged individually in order to reduce the overhead of retransmission.

A Prior art MSDU format is shown in FIG. 12. As shown in FIG. 12, a data packet transmitted into the air includes physical layer overhead (PHY header) and MAC protocol data unit (MPDU) 800 and tail & pad bits 805 as shown in the FIG. 12. Each MPDU 800 includes MAC layer overhead (MAC header) 801, MAC service protocol data unit (MSDU) 802 and Frame Check Sequence (FCS) 803 as shown in FIG. 12. FCS contains a specific bit sequence, such as CRC (Cyclic Redundancy Check) bit, that is being generated by an algorithm based on the content of MAC header and MSDU, which is used to check whether any error appears in the content. The sequence control number which is used to check the order of data unit is indicated in the MAC header.

### DISCLOSURE OF INVENTION

The invention provides a method to perform aggregation on data units that are queue at MAC in order to reduce overhead and to increase throughput efficiency without introducing unnecessary delay on data units transmission; an apparatus to facilitate aggregation and retransmission of each individual data units in order to achieve high throughput transmission.

According to the present invention, a composing method for composing a data compartment aggregation packet frame comprises: generating a plurality of data compartments, each having a compartment identifier, an MSDU and a compartment FCS; combining the data compartments to define a data carriage; generating a carriage header (203) to be located in front of the data carriage to define a carriage; generating a MAC header to be located in front of the carriage, said MAC header including a portion allocated with a unique bit pattern; and generating a frame FCS for error detection in the MAC header and the carriage.

According to the present invention, a composing apparatus for composing a data compartment aggregation packet frame comprises: means for generating one or more data compartments, each having a compartment identifier, an MSDU and a compartment FCS; means for combining the data compartments to define a data carriage; means for generating a carriage header to be located in front of the data carriage to define a carriage; means for generating a MAC header to be located in front of the carriage, said MAC header including a portion allocated with a unique bit pattern; and means for generating a frame FCS for error detection in the MAC header and the carriage.

According to the present invention, a decomposing method for decomposing a data compartment aggregation packet frame having a MAC header, carriage header and a plurality of data compartments, said decomposing method comprises: detecting a unique bit pattern located in a MAC header; separating data compartments; and processing the data compartments.

According to the present invention, a decomposing apparatus for decomposing a data compartment aggregation packet frame having a MAC header, carriage header and a plurality of data compartments, said decomposing apparatus comprises: means for detecting a unique bit pattern located in a MAC header; means for separating data compartments; and means for processing the data compartments.

According to the present invention, a computer readable data compartment aggregation packet frame comprises: a plurality of data compartments, each having a compartment identifier, an MSDU and a compartment FCS, said data compartments being aligned to define a data carriage; a carriage header located in front of the data carriage to define a carriage; a MAC header located in front of the carriage, said MAC header including a portion allocated with a unique bit pattern; and a frame FCS for error detection in the MAC header and the carriage.

### BRIEF DESCRIPTION OF DRAWINGS

FIG. 1 is a diagram showing a data structure of a MSDU aggregation packet frame format for a unicast recipient, according to the present invention;

FIG. 2 is a diagram showing a data structure of a MSDU aggregation packet frame format for a non-unicast recipient, according to the present invention;

FIG. 3 is a diagram showing a data structure of a MPDU aggregation packet frame format for a unicast recipient, according to the present invention;

FIG. 4 is a diagram showing a data structure of a MPDU aggregation packet frame format for a non-unicast recipient, according to the present invention;

FIG. 5 is a block diagram of an apparatus for generating aggregation packet frames according to the present invention;

FIG. 6 is a flowchart showing steps for generating aggregation packet frames according to the present invention;

FIG. 7 shows packet formats of the present invention in comparison with the prior art packet format;

FIG. 8 is a flowchart for decomposing the aggregation frame packet according to one embodiment;

FIG. 9 is a flowchart for decomposing the aggregation frame packet according to another embodiment;

FIG. 10 is a flowchart showing detail of the subroutine, compartment processing without error checking, used in the flowchart of FIG. 8;

FIG. 11 is a flowchart showing detail of the subroutine, compartment processing with error checking, used in the flowchart of FIGS. 8 and 9; and

FIG. 12 is a diagram showing a data structure of a prior art MSDU format.

### BEST MODE FOR CARRYING OUT THE INVENTION

In the following description, specific numbers, times, structures, and other parameters are used only for the purpose of thorough understanding of the present invention, and are not limited to those indicated.

To help understand the invention easier, the following definitions are used:

The term “Data flow” refers to a series of data units that are generated by an application. The orders of the generation of these data units must be maintained when they are received by the target entity.

The term “MAC” refers to a layer in OSI that is situated above physical layer, which is for controlling medium access in order to minimize collision but still provide each transmitting entities a fair share to access the medium.

The term “MAC Protocol Data unit” (MPDU) refers to a formatted unit that is generated by MAC for transmission.

The term “MAC Service Data unit” (MSDU) refers to an input unit from a layer above MAC that are to be formatted into MAC protocol data unit in order to be transmitted.

According to the present invention, two types of computer readable aggregation packet frames are proposed to improve transmission efficiency. The first one is called “MSDU aggregation packet frame” and the second one is called “MPDU aggregation packet frame”. Since MSDU and MPDU both are used to store data, the “MSDU aggregation packet frame” and the “MPDU aggregation packet frame” are herein generally referred to as a “data compartment aggregation packet frame”.

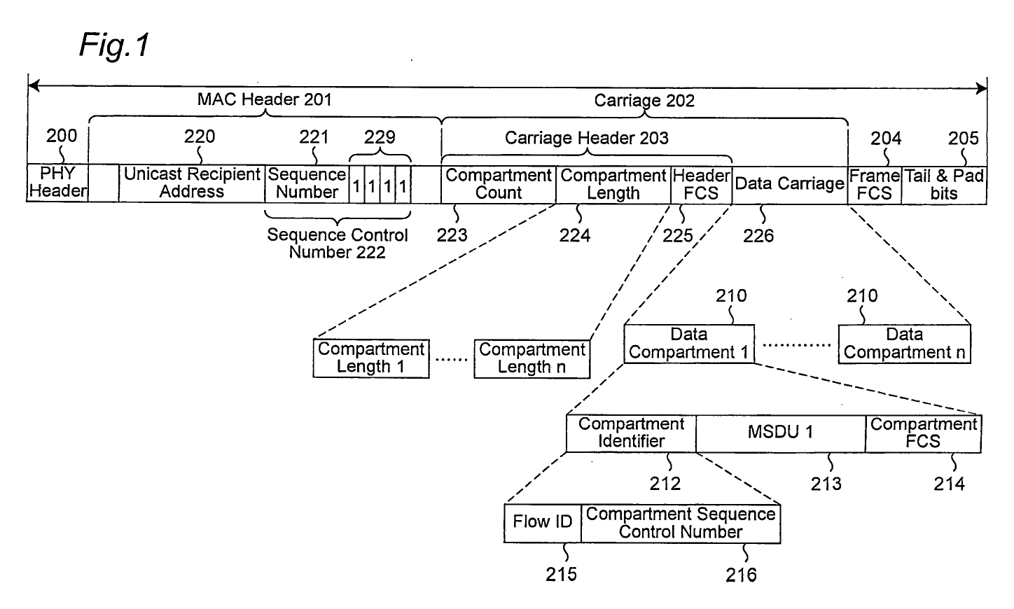

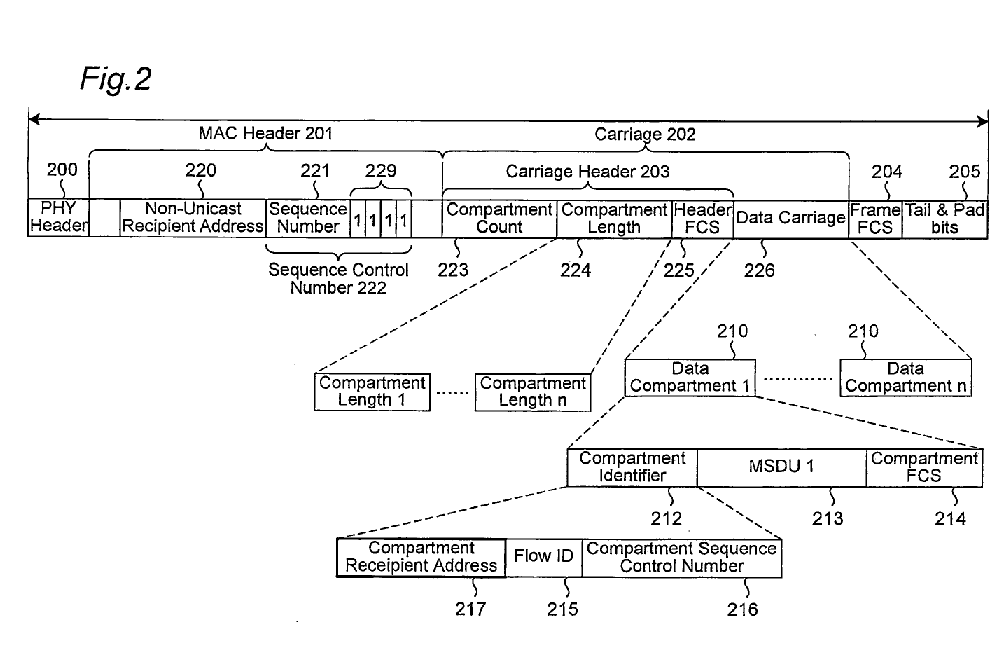

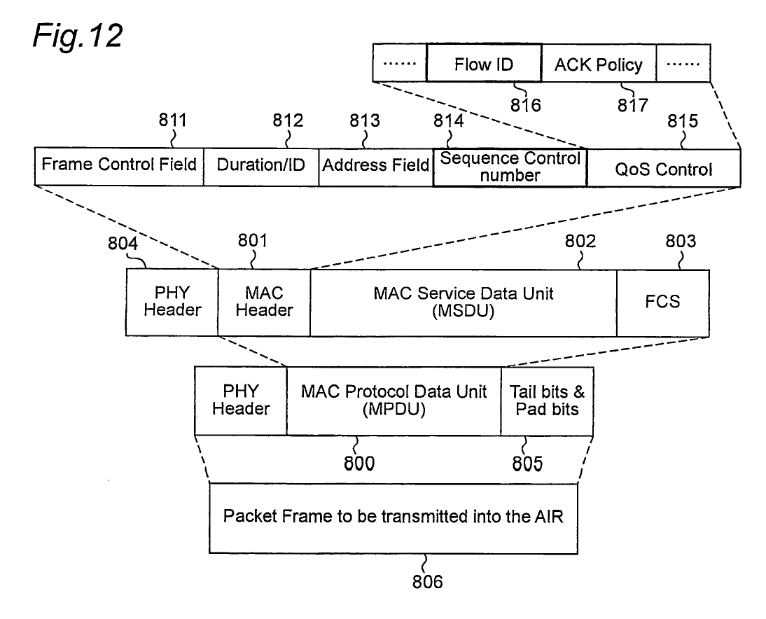

Referring to FIGS. 1 and 2, the MSDU aggregation packet frame format is shown. FIG. 1 particularly shows the unicast type, and FIG. 2 particularly shows the non-unicast type. The unicast type is used for sending the stream to a single recipient, while the non-unicast type is used for sending the stream to one or more recipients. The unicast type and the non-unicast type are very similar to each other, but are different only in two aspects: the address format in the recipient address 220; and the compartment recipient address 217 that is provided only in the non-unicast type. Other parts are the same. The description below is directed to the unicast type, and the description for the same parts in the non-unicast type are omitted. In the NASDU aggregation process, multiple MAC service data units (MSDUs) are being combined and being transmitted in the form of a single MSDU aggregation packet frame format. The MSDU aggregation packet frame format shown in FIG. 1 includes a physical header (PHY header) 200, MAC header 201, a Carriage 202, a Frame FCS (frame check sequence) 204 and a tail & pad bits 205. The MAC header 201 includes recipient address 220 and sequence control number 222. The carriage 202 is a place for holding a single or multiple MSDUs that are being delivered to MAC from a layer above MAC for further processing. The frame FCS 204 contains a specific sequence that is being generated by an algorithm base on the content of MAC header and the carriage, and the frame FCS 204 is used to check any errors that may exist in the frame, i.e, the integrity of those contents. In order to distinguish the present invention format (FIGS. 1 and 2) from the prior art MPDU format (FIG. 12), preselected identifier bits, such as the last four bits of sequence control number is set to a predetermined unique bit pattern 229, such as “1111”. If the last four bits of the sequence control number are not equal to the predetermined unique bit pattern 229, then the carriage contains only a data unit that is uniquely identified by the sequence control number. If the last four bits are equal to the predetermined unique bit pattern 229, then it is understood that the frame is a data compartment aggregation packet frame according to the present invention. In this case, the carriage includes 2 segments, which are carriage header 203 and data carriage 226. The preselected identifier bits can be any other bits than those last four bits of the sequence control number. Also, the predetermined unique bit pattern 229 can be any other pattern than “1111”. Also, the unique bit pattern 229 can be located in MAC header, but in a place other than the sequence control number. In other words, the MAC header includes a portion allocated with a unique bit pattern 229.

The carriage header includes 3 fields which are compartment count 223, compartment length information 224 and header FCS 225. The compartment count 223 is used to indicate the number of compartments in the data carriage. The compartment length information 224 includes a list of lengths for each corresponding compartment. The header FCS 225 is a checksum that is generated for the content of MAC header, compartment count and compartment lengths.

The data carriage 226 is a place for holding one or a plurality of data compartments, which is referred to as a data compartment array. Each data compartment 210 has only a compartment identifier 212, a MSDU 213 and a compartment FCS 214. No other element is included in the data compartment 210. The compartment identifier 212 is used to identify the data units in the MSDU field.

If the recipient address 220 is a unicast address, as shown in FIG. 1, then compartment identifier 212 includes only a flow identifier (ID) 215 and a compartment sequence control number 216. The flow ID 215 is an ID that is used to identify a data flow. The compartment sequence control number 216 is a sequence number that uniquely identify the data units in the data field of a flow. In a modified embodiment (not shown), the flow ID 215 can be omitted. Thus, in such a modified embodiment, the compartment identifier 212 includes only compartment sequence control number 216.

If the recipient address is a non-unicast address, as shown in FIG. 2, then compartment identifier 212 includes only a compartment recipient address 217, a flow ID and a compartment sequence control number. The non-unicast address represents a multi-destination address, associated with one or more stations on a given network. It is usually indicated with predetermined address value which can be recognized by one or more stations. In a modified embodiment (not shown), the flow ID 215 can be omitted. Thus, in such a modified embodiment, the compartment identifier 212 includes only compartment recipient address 219 and compartment sequence control number 216.

The compartment recipient address 217 is used to indicate the target recipient of the data unit in the compartment. The non-unicast address 220 of FIG. 2 is used by the receiving stations to indicate that there is a payload in the data compartment for the receiving station using the compartment recipient address. The MSDU 213 is a place for holding a MAC service data unit. The compartment FCS 214 is the checksum for the compartment. Each MSDU 213 in a data compartment is identified by a compartment sequence control number 216, which is used to facilitate retransmission of each individual MAC service data unit. Instead of the checksum, other error detection code can be used.

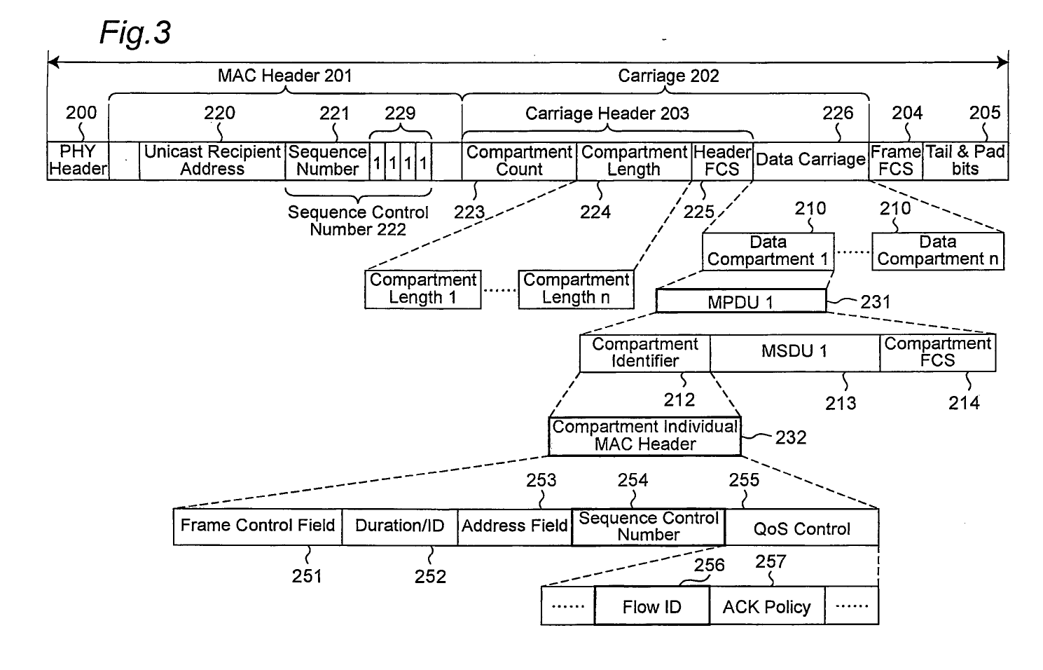

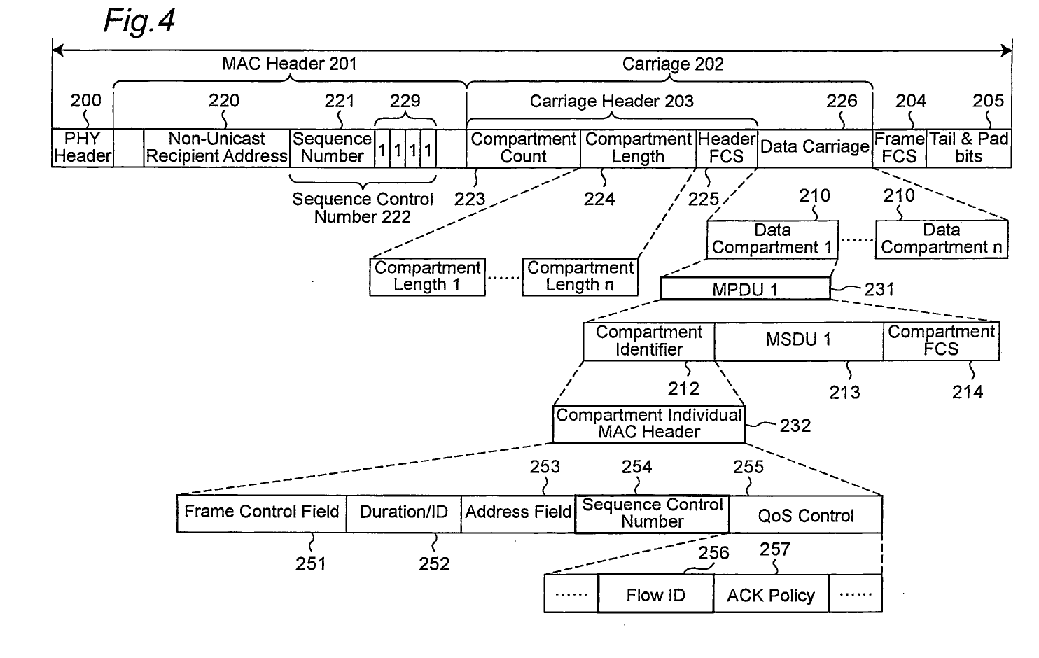

Referring to FIGS. 3 and 4, the MPDU aggregation packet frame format is shown. FIG. 3 particularly shows the unicast type, and FIG. 4 particularly shows the non-unicast type. The unicast type and the non-unicast type are very similar to each other, but are different only in one aspect: the address format in the recipient address 220. Other parts are the same. The description below is directed to the unicast type, and the description for the same parts in the non-unicast type are omitted. In the MPDU aggregation process, multiple MAC protocol data units (MPDUs) are being combined and being transmitted in the form of a single MPDU aggregation packet frame format. The MPDU aggregation packet frame format as shown in FIG. 3 includes a PHY header 200, MAC header 201, a carriage 202, a frame FCS 204 and a tail & pad bits 205. The MAC header includes recipient address 220 and sequence control number 221. The carriage 202 is a place for holding a single or multiple MPDUs that are being delivered to MAC from a layer above MAC for further processing. The frame FCS 204 contains a specific sequence that is generated by an algorithm base on the content of MAC header and the carriage, and is used to check any errors that may exist in the frame, i.e., the integrity of those contents.

In order to distinguish the present invention format (FIGS. 3 and 4) from the prior art MPDU format (FIG. 12), preselected identifier bits, such as the last four bits of sequence control number is set to a predetermined unique bit pattern 229, such as “1111”. If the last four bits of the sequence control number are not equal to the predetermined unique bit pattern 229, then the carriage contains only a data unit that is uniquely identified by the sequence control number. If the last four bits are equal to the predetermined unique bit pattern 229, then the carriage includes 2 segments, which are carriage header 203 and data carriage 226. The preselected identifier bits can be any other bits than those last four bits of the sequence control number. Also, the predetermined unique bit pattern 229 can be any other pattern than “1111”. Also, the unique bit pattern 229 can be located in MAC header, but in a place other than the sequence control number.

The carriage header includes 3 fields which are compartment count 223, compartment length information 224 and header FCS 225. The compartment count 223 is used to indicate the number of compartments in the data carriage. The compartment length information 224 includes a list of lengths for each corresponding compartment. The header FCS 225 is a checksum that is generated for the content of MAC header, compartment count and compartment lengths.

The data carriage 226 is a place for holding a plurality of data compartments, which is referred to as a data compartment array. Each data compartment 210 has an entire MPDU 231. In other words, in this embodiment, the data compartment is the same as the MPDU. Each MPDU contains compartment identifier 212, a MSDU 213 and a compartment FCS 214. The compartment identifier 212 is used to identify the data units in the MSDU field. The compartment identifier 212 is also referred to as a compartment individual MAC header 232 associated with the MSDU 213.

The compartment individual MAC header 232 includes a frame control 251, a duration/ID 252, an address field 253, a sequence control number 254 and a QoS control 255. The QoS control 255 includes a flow ID 256 and an ACK policy 257. The flow ID 256 is used to identify a data flow. The sequence control number 254 is used to uniquely identify the MSDU of a flow. If the recipient address is a non-unicast address 220 which represents a multi-destination address, associated with one or more stations on a given network, then the address field 253 is also used to indicate the target recipient of the MSDU in the compartment. The non-unicast address 220, as shown in FIG. 4 is used by the receiving stations to indicate that there is a payload in the compartment for the receiving station using the address field 253. Moreover, it is usually indicated with a predetermined address value which can be recognized by one or more stations.

The MSDU field 213 is a place for holding a MAC service data unit. The compartment FCS field 214 is the checksum for the compartment. Each MSDU in a compartment is being identified by a sequence control number, which is used to facilitate retransmission of each individual MAC service data unit.

In any of the streams shown in FIGS. 1, 2, 3 and 4, the frame FCS 204 can be omitted, or a dummy data can be placed.

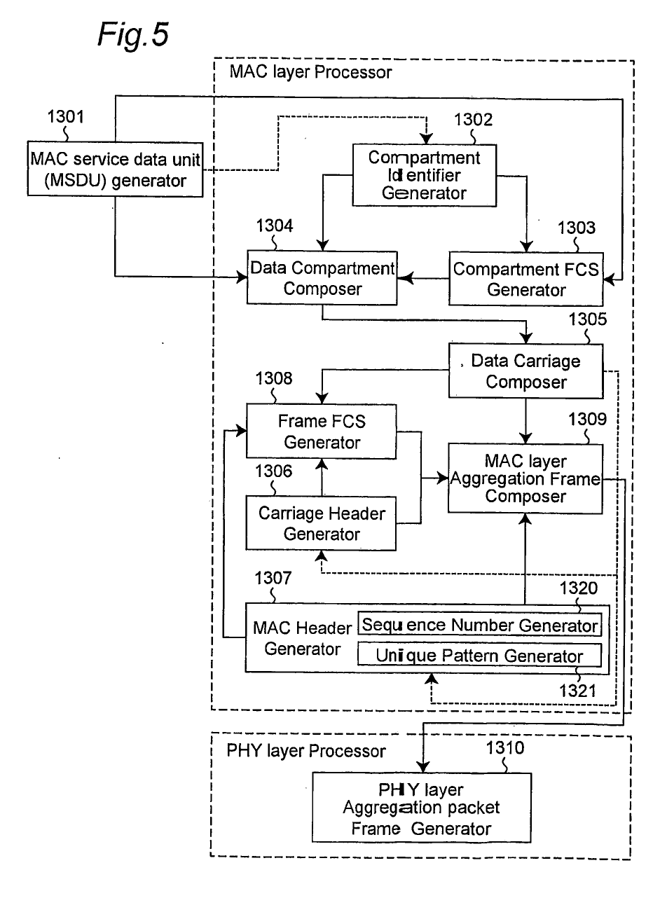

Referring to FIG. 5, an apparatus for generating aggregation packet frames according to the present invention is shown. The apparatus includes a MSDU generator 1301 for generating MSDU 213, a compartment identifier generator for generating compartment identifier 212, and a compartment FCS generator 1303 for generating compartment FCS 214. MSDU 213, compartment identifier 212 and compartment FCS 214 are applied to a data compartment composer 1304 at which data compartment 210 is formed. One or more data compartments 210 are applied to data carriage composer 1305 at which data carriage 226 is formed. A carriage header generator 1306 generates carriage header 203, and a MAC header generator 1307 generates MAC header 201. MAC header generator 1307 includes a sequence number generator 1320 for generating sequence number 221 and a unique number generator 1321 for generating the unique number, such as “1111”. The sequence number and the unique number are combined in a predetermined manner to form sequence control number 222. The MAC header 201 and the carriage header 203 are applied to a frame FCS generator 1308 for generating frame FCS 204. Data carriage 226, carriage header 203 and MAC header 201 are applied to a MAC layer aggregation frame composer 1309, at which a stream shown in FIG. 1, 2, 3 or 4, but without the PHY header 200 and tail and pad bits 205, is generated. The stream as generated in MAC layer aggregation frame 1309 is applied to a PHY layer aggregation packet frame generator 1310 at which the PHY header 200 is added. The tail and pad bits 205 can be added either in MAC layer aggregation frame composer 1309 or in PHY layer aggregation packet frame generator 1310. In FIG. 5, the blocks 1302 to 1309 define a MAC layer processor, and the block 1310 define a PHY layer processor.

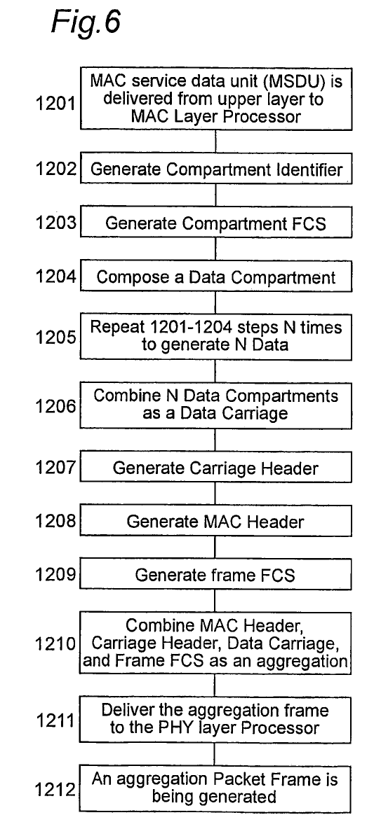

Referring to FIG. 6, a process for generating an aggregation packet frames according to the present invention is shown.

At step 1201, MSDU 213 is generated by MSDU generator 1301 and delivered from upper layer to MAC layer Processor.

At step 1202, compartment identifier generator 1302 generates a compartment identifier 212 corresponding to the MSDU 213 generated at step 1201.

At step 1203, compartment FCS generator 1302 generates a compartment FCS 214 based on the contents of the MSDU 213 and compartment identifier 212 generated at steps 1201 and 1202.

At step 1204, data compartment composer 1304 composes a data compartment 210 using the MSDU 213, compartment identifier 212 and compartment FCS 214 generated at steps 1201, 1202 and 1202.

At step 1205, steps 1201 to 1204 are repeated N times (N is a positive integer) to generate N data compartments.

At step 1206, data carriage composer 1305 composes a data carriage 226 by combining the N data compartments generated in step 1205.

At step 1207, carriage header generator 1306 generates a carriage header 203 for the data carriage 226 generated in step 1206.

At step 1208, MAC header generator 1307 generates a MAC Header 201 for the data carriage 226 generated in step 1206.

At step 1209, frame FCS generator 1308 generates a frame FCS 204 based on the contents of the data carriage 226, carriage header 203, and MAC header 201 generated in steps 1206-1208.

At step 1210, MAC layer aggregation frame composer 1309 composes an aggregation frame using the data carriage 226, carriage header 203, MAC header 201 and frame FCS 204 generated in steps 1206-1209.

At step 1211, the aggregation frame is delivered to the PHY (physical) layer processor.

At step 1212, PHY layer aggregation packet frame generator 1310 generates an aggregation packet frame.

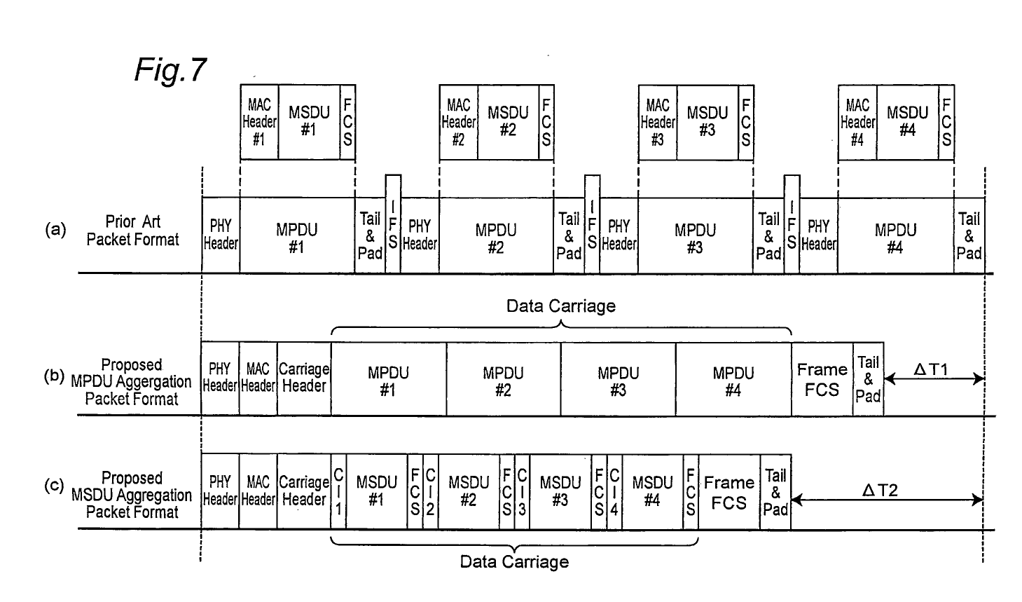

Referring to FIG. 7, an improvement of transmission efficiency using any one of the proposed MPDU or MSDU aggregation shown in FIG. 1, 2, 3 or 4 is shown.

FIG. 7 (a) shows a transmission stream for sending four MSDUs according to prior art standard regulations, such as IEEE 802.11, as shown in FIG. 12. As shown in FIG. 7 (a), each MSDU is sandwiched between a MAC header and an FCS, defining a MPDU. Each MPDU is further sandwiched between a PHY header and a tail & pad bits defining a packet frame. Each packet frame is further separated by an inter frame space (IFS).

FIG. 7 (b) shows a transmission stream for sending four MSDUs according to the MPDU aggregation of the present invention shown in FIG. 3 or 4. As shown in FIG. 7 (b), four MPDUs, which are also referred to as data compartments, are aligned one after another without any substantial interval to define a data compartment array. Each MPDU has a structure similar to that shown in FIG. 7 (a) and contains one MSDU. The only difference is that the MPDU of FIG. 7 (b) has a compartment individual MAC header instead of MAC header provided in MPDU of FIG. 7 (a). When the stream of FIG. 7 (b) is compared with that of FIG. 7 (a), the PHY header and the tail & pad bits are omitted in each MPDU, but are provided for the MPDU array. The four MSDUs can share the same PHY header and the same tail & pad bits provided at the leading and the trailing ends, respectively, of the stream. Also, the inter frame space (IFS) is omitted. Thus, for sending the same amount of data, the stream of FIG. 7 (b) is shorter than the stream of FIG. 7 (a) by ΔT1.

FIG. 7 (c) shows a transmission stream for sending four MSDUs according the MSDU aggregation of the present invention shown in FIG. 1 or 2. As shown in FIG. 7 (c), each MSDU is sandwiched between compartment identifier and compartment FCS defining a data compartment, and four data compartments are aligned one after another without any substantial interval to define a data compartment array. When the stream of FIG. 7 (c) is compared with that of FIG. 7 (a), the PHY header and the tail & pad bits are omitted in each MPDU, but are provided for the MPDU array. Also, the inter frame space is omitted. Furthermore, when the stream of FIG. 7 (c) is compared with that of FIG. 7 (b), the compartment identifier is made shorter than the compartment individual MAC header. Thus, for sending the same amount of data, the stream of FIG. 7 (c) is shorter than the stream of FIG. 7 (a) by ΔT2, which is greater than ΔT1.

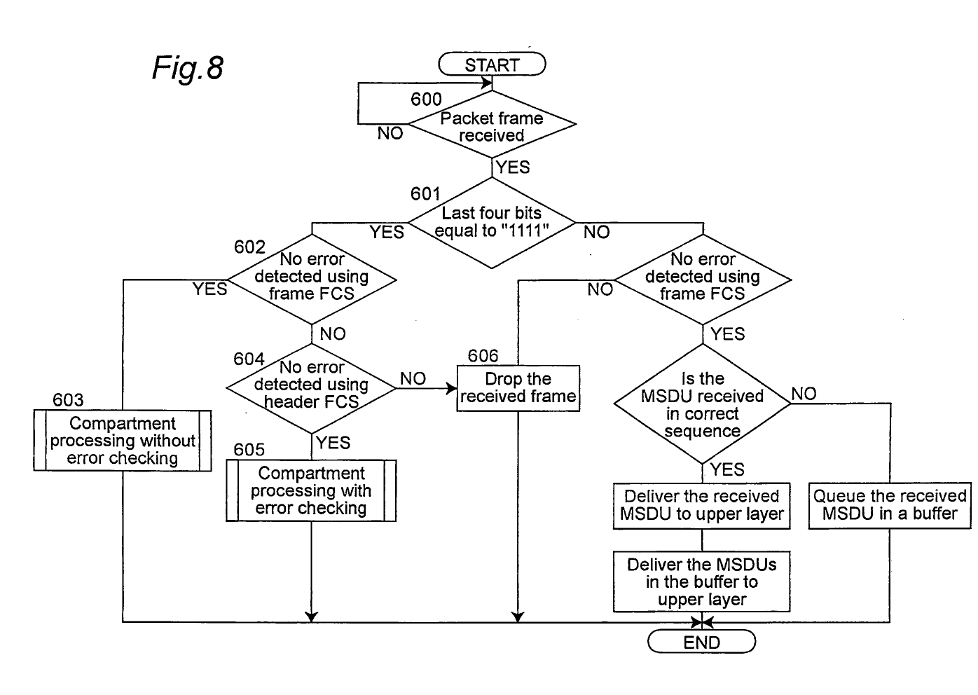

Referring to FIG. 8, a flowchart for the aggregation frame decomposition process is shown.

At step 600, it is detected whether or not a packet frame, which is any one of that shown in FIGS. 1, 2, 3, 4 and 12, is received.

At step 601, it is detected whether or not the last four bits of the sequence control number of the received packet frame is equal to “1111”. If yes, the program goes to step 602, but if not, the program according to the known MPDU process is carried out.

At step 602, the error detection using the frame FCS is carried out. Specifically, the checksum of the received packet frame is generated in the receiver side and is compared with the checksum carried in the frame FCS. If the generated checksum is equal to the checksum in the frame FCS, it is determined that no error exists in the received packet frame and thus the program goes to step 603, and if not the program goes to step 604.

At step 604, the error detection using the header FCS is carried out. Specifically, the checksum of the received MAC header and the carriage header is generated in the receiver side and is compared with the checksum carried in the header FCS. If the generated checksum is equal to the checksum in the header FCS, it is determined that no error exists in the received MAC header and the carriage header and thus the program goes to step 605, and if not the program goes to step 606, at which step the frame is determined to be a defect frame and is dropped.

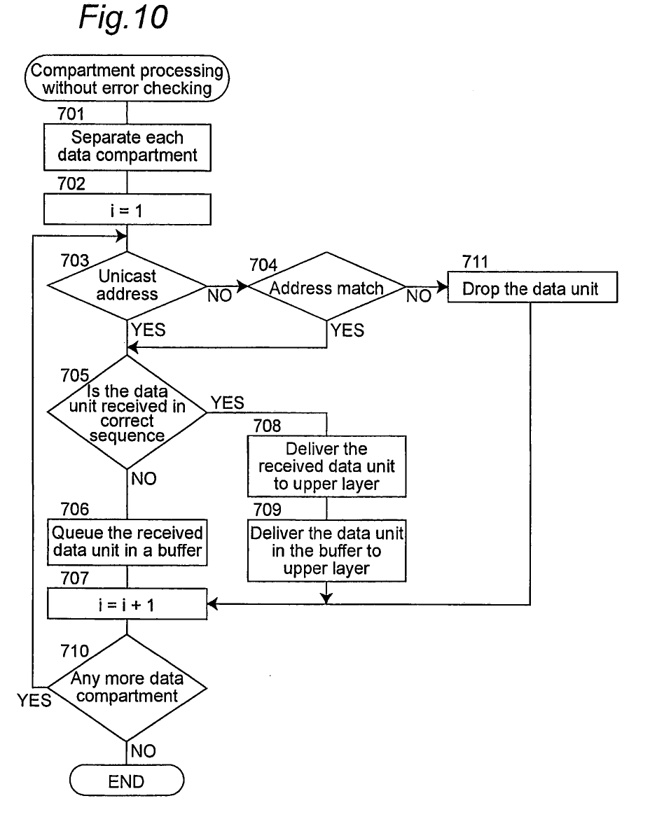

At step 603, a compartment processing without error checking is carried out, and its detail is shown in FIG. 10.

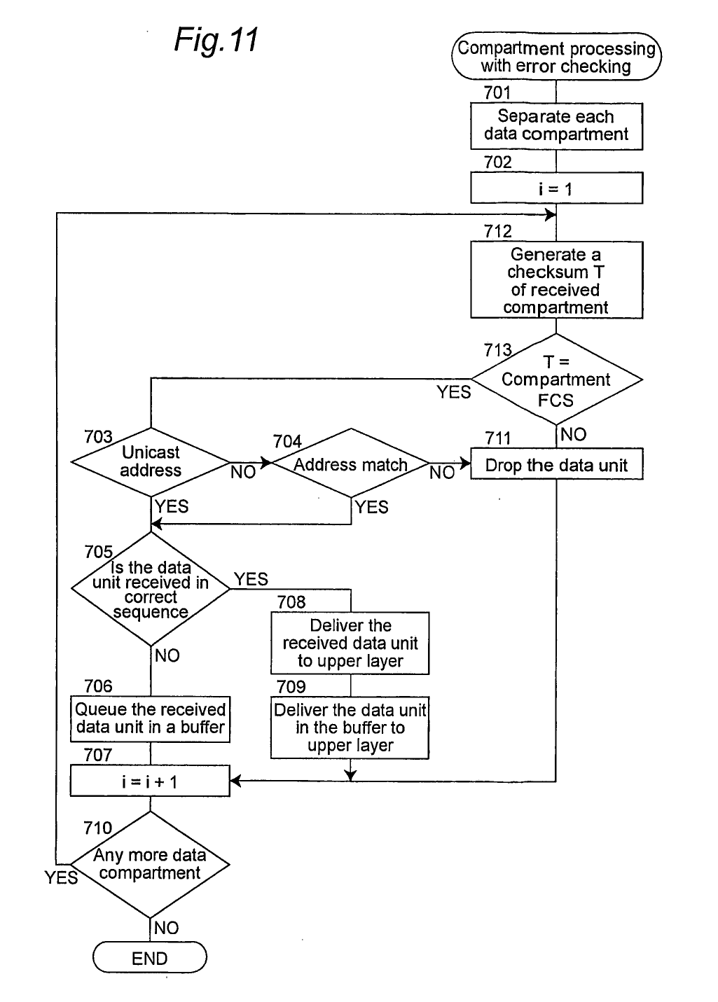

At step 605, a compartment processing with error checking is carried out, and its detail is shown in FIG. 11.

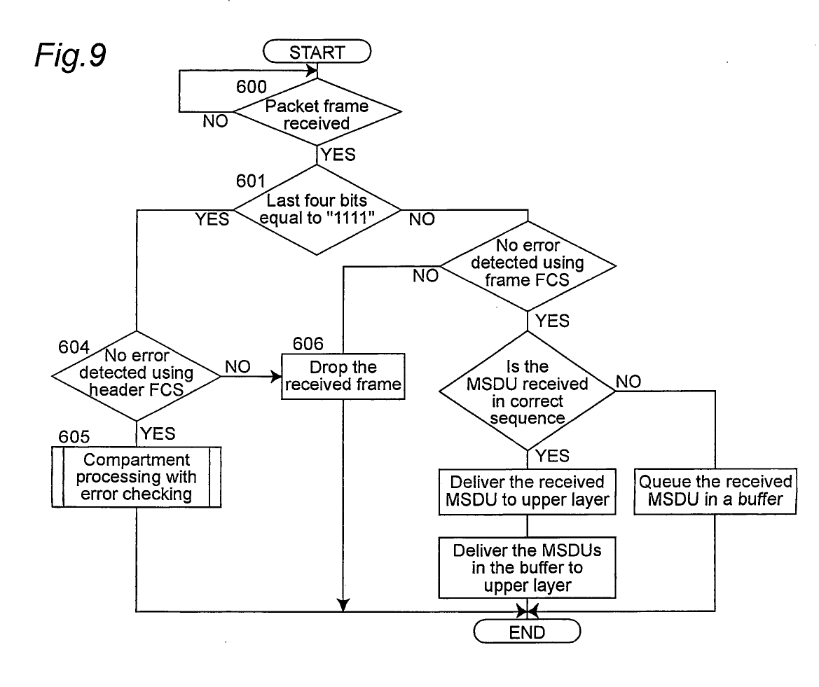

Referring to FIG. 9, a flowchart similar to that shown in FIG. 8 is shown, but differs in that the steps 602 and 603 are eliminated. As apparent from any one of FIGS. 1, 2, 3 and 4, a packet frame format has three FCSs, the header FCS 225, the compartment FCS 214 and the frame FCS 204.

The flowchart of FIG. 8 uses all the three FCSs. First, the frame FCS is used to check the error in the entire packet frame, and if no error is found, the data compartments are separated and processed. If any error is found by using the frame FCS, then the header FCS is used to check the error in the MAC header 201 and the carriage header 203. If any error is found by using the header FCS, then the entire frame data is dropped and disregarded. If no error is found by using the header FCS, then compartment FCS is used to check the error in each data compartment. If any error is found by using the compartment FCS, the data compartment is dropped and disregarded. If no error is found by using the compartment FCS, the compartment is processed.

Generally, to perform verification of the frame FCS before individual compartment FCS as described in FIG. 8 may requires long processing time because the frame FCS is located at end of the frame. Accordingly, in some cases verification of the frame FCS may be neglected in order to reduce the process time. FIG. 9 shows a flowchart for aggregation frame decomposition process when the frame FCS 204 is not being used.

The flowchart of FIG. 9 uses only two FCSs, the header FCS and the compartment FCS. First, the header FCS is used to check the error in the MAC header 201 and the carriage header 203. If any error is found by using the header FCS, then the entire frame data is dropped and disregarded. If no error is found by using the header FCS, then compartment FCS is used to check the error in each data compartment. If any error is found by using the compartment FCS, the data compartment is dropped and disregarded. If no error is found by using the compartment FCS, the compartment is processed. Since the flowchart of FIG. 9 takes no step for checking the frame FCS, the procedure is shortened and simplified.

Referring to FIG. 10, a flowchart of the compartment processing without error checking is shown.

At step 701, the data compartments in the data carriage are separated, and are processed one after the other. Before processing the first data carriage, a counter is set to “1” at step 702.

At step 703, it is detected whether or not the data component is a unicast address. If yes, the program goes to step 705, and if no, to step 704.

At step 704, since the data component is for a non-unicast address, the address of the received data component is compared with the address of the received machine. If they match, the data component is delivered correctly and the program goes to step 705, and if not, the data component is dropped.

At step 705, it is detected whether or not the received data component (here, data compartment can be a data unit or a MSDU) is in correct sequence order. If yes, the program goes to step 708, and if no, the program goes to step 706. When the previous received data component had a sequence number N, the newly received data component should have a sequence number N+1. If the newly received data component has a sequence number N+2, it is detected that the data component with a sequence number N+1 is missing. In this case, the newly received data component is stored in a buffer at step 706. In the next cycle of operation, if the received data component has a sequence number N+1, it is detected that a correct data component is received. In this case, the received data component is delivered to an upper layer for further processing. Then, at step 709, the data, i.e., the data component with a sequence number N+2, stored in the buffer is delivered to an upper layer for further processing.

At step 707, the counter is incremented by one. At step 710, it is detected whether or not any further data component is left. If yes, the program returns to step 703, and if no, the program ends.

Referring to FIG. 11, a flowchart of the compartment processing with error checking using the compartment FCS is shown. The flowchart of FIG. 11 further has steps 712 and 713 between steps 702 and 703 of FIG. 10.

At step 712, a checksum T of the received data compartment is generated. At step 713, the generated checksum T is compared with the compartment FCS. If they are equal, it is detected that no error exists. In this case, the program goes to step 703. If they are not equal, it is detected that an error exists. In this case, the program goes to step 711 to drop the data unit in the data compartment.

A decomposing apparatus for decomposing the data compartment aggregation packet frame can be accomplished by the flowcharts shown in FIGS. 8, 9, 10 and 11, and should include a detector for detecting a unique bit pattern 229 located in a MAC header, a separator for separating data compartments 210, and a processor for processing the data compartments.

According to the present invention, since the PHY header and the tail & pad bits are eliminated from each data compartment (corresponding to the MPDU), the data length can be shortened. Furthermore, in each data compartment, the compartment identifier (corresponding to the MAC header) includes only the necessary items, the data length can be shortened. Furthermore, according to the present invention, the data compartments are aligned without any inter frame space, the data length can be shortened.

### INDUSTRIAL APPLICABILITY

The present invention can be applied to the method and apparatus for generating packet frames for carrying data.

1. A composing method for composing a data compartment aggregation packet frame comprising:
generating a plurality of data compartments, each having a compartment identifier, an MSDU and a compartment FCS;
combining the data compartments to define a data carriage;
generating a carriage header to be located in front of the data carriage to define a carriage;
generating a MAC header to be located in front of the carriage, said MAC header including a portion allocated with a unique bit pattern; and
generating a frame FCS for error detection in the MAC header and the carriage.

2. A composing method of claim 1, wherein said carriage header includes a compartment count indicating the number of data compartments, a compartment length information indicating the length of each of the data compartment and a header FCS.

3. A composing method of claim 1, wherein said compartment identifier includes only a compartment sequence control number.

4. A composing method of claim 1, wherein said compartment identifier includes only a flow identifier and a compartment sequence control number.

5. A composing method of claim 1, wherein said compartment identifier includes only a compartment recipient address, and a compartment sequence control number.

6. A composing method of claim 1, wherein said compartment identifier includes only a compartment recipient address, a flow identifier and compartment sequence control number.

7. A composing method of claim 1, wherein said compartment identifier includes a MAC header.

8. A composing apparatus for composing a data compartment aggregation packet frame comprising:
means for generating one or more data compartments, each having a compartment identifier, an MSDU and a compartment FCS;
means for combining the data compartments to define a data carriage;
means for generating a carriage header to be located in front of the data carriage to define a carriage;
means for generating a MAC header to be located in front of the carriage, said MAC header including a portion allocated with a unique bit pattern; and
means for generating a frame FCS for error detection in the MAC header and the carriage.

9. A composing apparatus of claim 8, wherein said carriage header includes a compartment count indicating the number of data compartments, a compartment length information indicating the length of each of the data compartment and a header FCS.

10. A composing apparatus of claim 8, wherein said compartment identifier includes only a compartment sequence control number.

11. A composing apparatus of claim 8, wherein said compartment identifier includes only a flow identifier and a compartment sequence control number.

12. A composing apparatus of claim 8, wherein said compartment identifier includes only a compartment recipient address, and a compartment sequence control number.

13. A composing apparatus of claim 8, wherein said compartment identifier includes only a compartment recipient address, a flow identifier and compartment sequence control number.

14. A composing apparatus of claim 8, wherein said compartment identifier includes a MAC header.

15. A decomposing method for decomposing a data compartment aggregation packet frame having a MAC header, carriage header and a plurality of data compartments, said decomposing method comprising:
detecting a unique bit pattern located in a MAC header;
separating data compartments; and
processing the data compartments.

16. A decomposing apparatus for decomposing a data compartment aggregation packet frame having a MAC header, carriage header and a plurality of data compartments, said decomposing apparatus comprising:
means for detecting a unique bit pattern located in a MAC header;
means for separating data compartments; and
means for processing the data compartments.

17. A computer readable data compartment aggregation packet frame comprising:
a plurality of data compartments, each having a compartment identifier, an MSDU and a compartment FCS, said data compartments being aligned to define a data carriage;
a carriage header located in front of the data carriage to define a carriage;
a MAC header located in front of the carriage, said MAC header including a portion allocated with a unique bit pattern; and
a frame FCS for error detection in the MAC header and the carriage.

18. A computer readable data compartment aggregation packet frame of claim 17, wherein said carriage header includes a compartment count indicating the number of data compartments, a compartment length information indicating the length of each of the data compartment and a header FCS.

19. A computer readable data compartment aggregation packet frame of claim 17, wherein said compartment identifier includes only a compartment sequence control number.

20. A computer readable data compartment aggregation packet frame of claim 17, wherein said compartment identifier includes only a flow identifier and a compartment sequence control number.

21. A computer readable data compartment aggregation packet frame of claim 17, wherein said compartment identifier includes only a compartment recipient address, and a compartment sequence control number.

22. A computer readable data compartment aggregation packet frame of claim 17, wherein said compartment identifier includes only a compartment recipient address, a flow identifier and compartment sequence control number.

23. A computer readable data compartment aggregation packet frame of claim 17, wherein said compartment identifier includes a MAC header.

24. A composing method of claim 1, wherein said compartment identifier includes a compartment recipient address, and said MAC header includes a non-unicast recipient address.
